(19) United States
(12) Patent Application Publication
(10) Pub. No.: US 2017/0095113 A1
(43) Pub. Date: Apr. 6, 2017

(54) Muffin Cooking System

(71) Applicant: Trent Cox, North Salt Lake, UT (US)

(72) Inventor: Trent Cox, North Salt Lake, UT (US)

(21) Appl. No.: 14/873,788

(22) Filed: Oct. 2, 2015

(51) Int. Cl. A47J 37/01; A47J 36/34

(52) U.S. Cl. CPC A47J 37/01; A47J 36/34

(57) ABSTRACT

A muffin cooking system includes a pan that has a plurality of indentions. The indentions are spaced apart from each other and are distributed on the pan. A rack is removably positioned on the pan. The rack has a plurality of baskets and each of the baskets may contain a muffin. Each of the baskets is positioned in an associated one of the indentions when the rack is removably positioned on the pan. Thus, the rack may cook the muffins. The rack is removed from the pan when the muffins are cooked and the rack the muffins are cooled.

### BACKGROUND OF THE DISCLOSURE

Field of the Disclosure

The disclosure relates to cooking devices and more particularly pertains to a new cooking device for cooking and cooling muffins.

### SUMMARY OF THE DISCLOSURE

An embodiment of the disclosure meets the needs presented above by generally comprising a pan that has a plurality of indentions. The indentions are spaced apart from each other and are distributed on the pan. A rack is removably positioned on the pan. The rack has a plurality of baskets and each of the baskets may contain a muffin. Each of the baskets is positioned in an associated one of the indentions when the rack is removably positioned on the pan. Thus, the rack may cook the muffins. The rack is removed from the pan when the muffins are cooked and the rack the muffins are cooled.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a muffin cooking system according to an embodiment of the disclosure.

FIG. 2 is a left side view of an embodiment of the disclosure.

FIG. 3 is a top view of an embodiment of the disclosure.

FIG. 4 is a cross sectional view taken along line 4-4 of FIG. 3 of an embodiment of the disclosure.

FIG. 5 is a perspective in-use view of an embodiment of the disclosure.

### DESCRIPTION OF THE PREFERRED EMBODIMENT

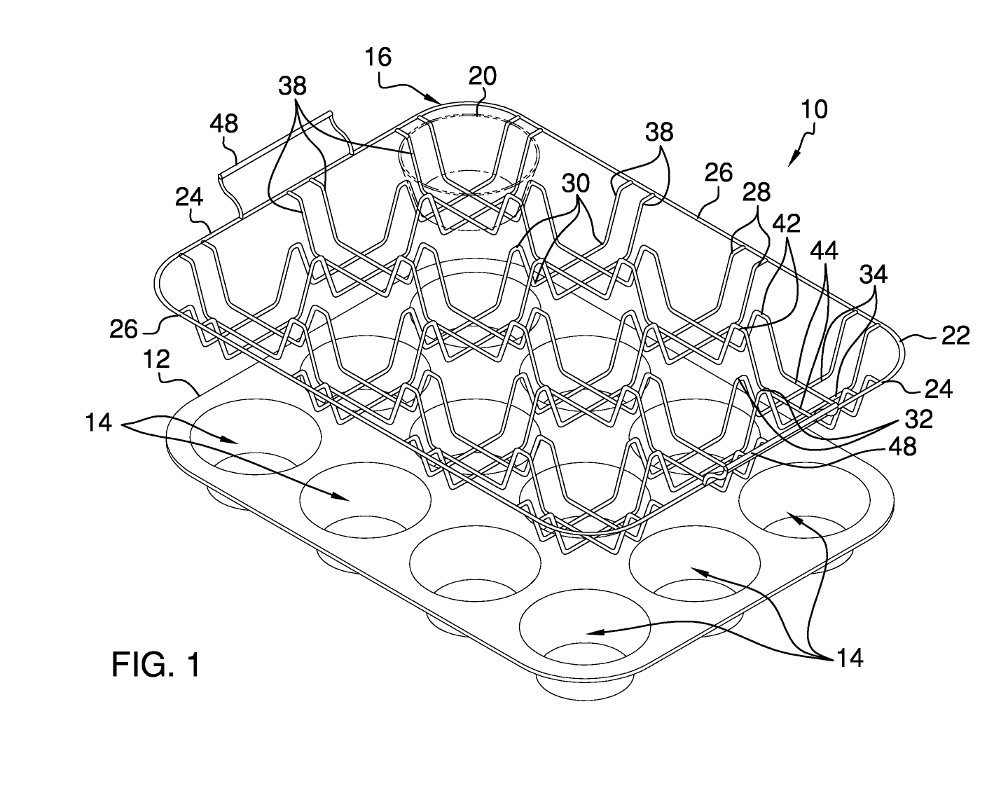

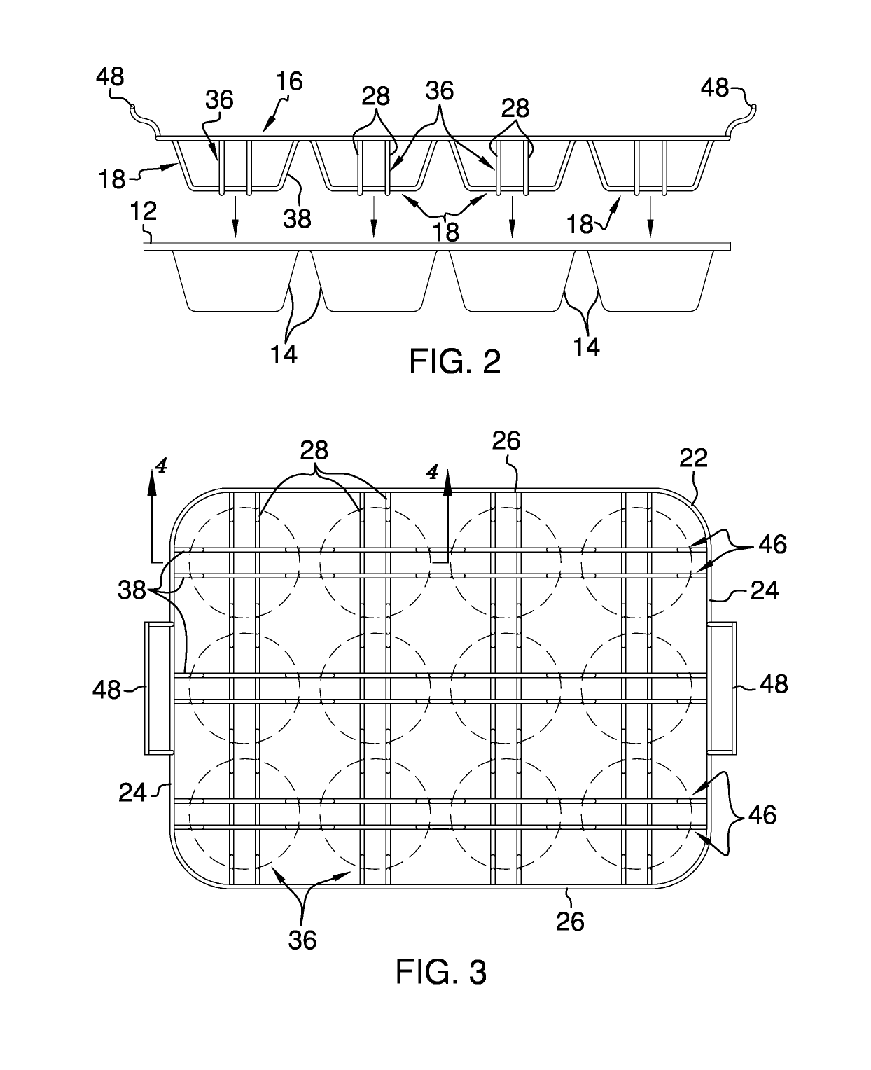

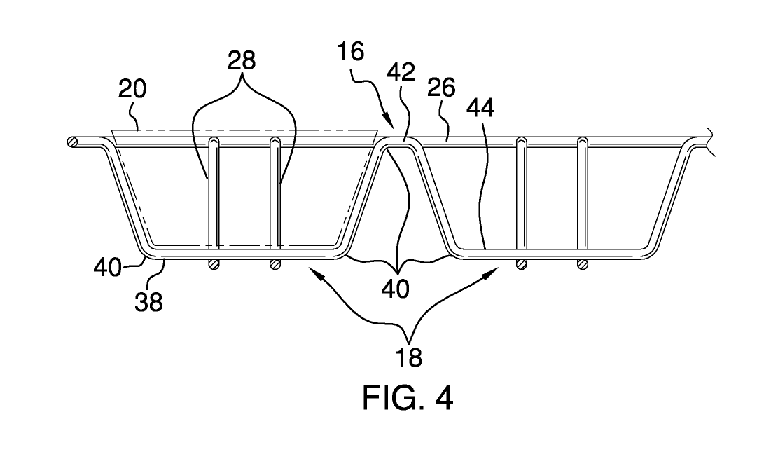

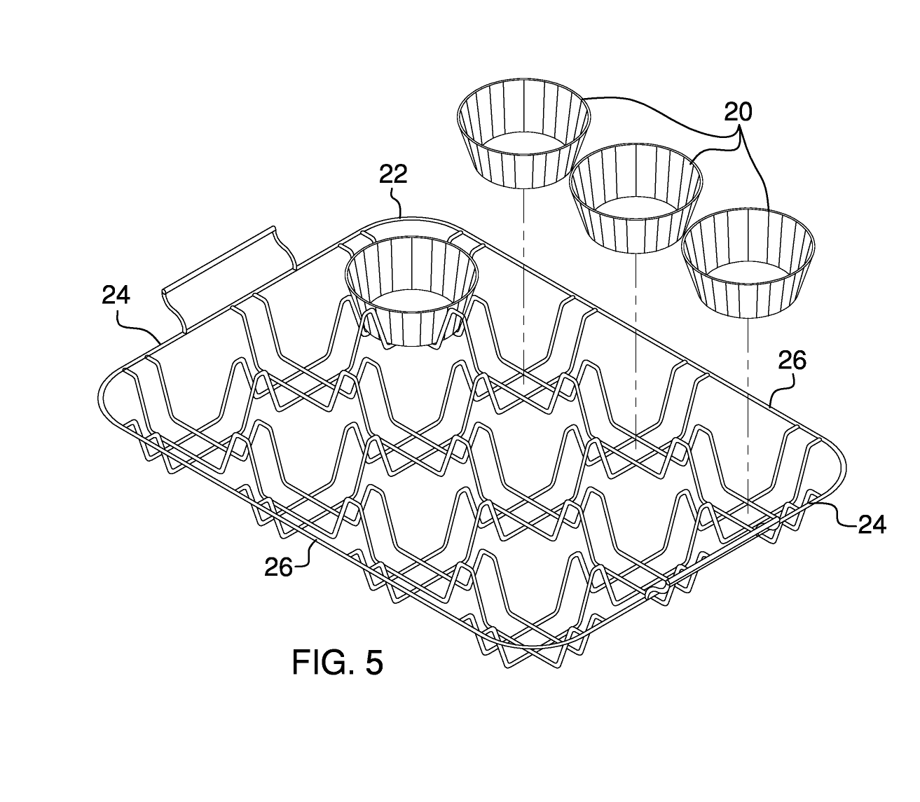

With reference now to the drawings, and in particular to FIGS. 1 through 5 thereof, a new cooking device embodying the principles and concepts of an embodiment of the disclosure and generally designated by the reference numeral 10 will be described.

As best illustrated in FIGS. 1 through 5, the muffin cooking system 10 generally comprises a pan 12 that has a plurality of indentions 14. The indentions 14 are spaced apart from each other and are distributed on the pan 12. The pan 12 may comprise a muffin pan or the like. Additionally, the pan 12 may have a variety of widths and lengths.

A rack 16 is removably positioned on the pan 12. The rack 12 has a plurality of baskets 18 and each of the baskets 18 may contain a muffin 20. Each of the baskets 18 is positioned in an associated one of the indentions 14 when the rack 16 is removably positioned on the pan 12. Thus, the rack 16 cooks the muffins 20 when the pan 12 and the rack 16 are placed in an oven. The rack 16 is removed from the pan 12 when the muffins 20 are cooked. Thus, the muffins 20 are cooled after the muffins 20 are cooked. The rack 16 facilitates the muffins 20 to be removed from the pan 12 without damaging the muffins 20.

The rack 16 comprises an outer frame 22 and the outer frame 22 has a pair of lateral members 24 extending between a pair of longitudinal members 26. The lateral members 24 are spaced apart from each other such that the rack 16 has a rectangular shape. The outer frame 22 may have a variety of widths and lengths.

The rack 16 includes a plurality of first supports 28 and each of the first supports 28 is coupled to and extends between the pair of longitudinal members 26. The first supports 28 are spaced apart from each other and distributed along each of the longitudinal members 26. Each of the first supports 28 has a plurality of bends 30 thereon. The bends 30 are spaced apart from each and other to define an alternating sequence of hills 32 and valleys 34 on each of the first supports 28. The first supports 28 may be arranged into a plurality of sets 36 of the first supports 28. The sets of first supports 36 may be spaced apart from each other and distributed along the longitudinal members 26.

The rack 16 includes a plurality of second supports 38 and each of the second supports 38 is coupled to and extends between the pair of lateral members 24. The second supports 38 are spaced apart from each other and are distributed along each of the lateral members 24. Each of the second supports 38 has a plurality of bends 40 thereon. The bends 40 are spaced apart from each and other to define an alternating sequence of hills 42 and valleys 44 on each of the second supports 38. The second supports 38 may be arranged into a plurality of sets of the second supports 46. The set of second supports 46 may be spaced apart from each other and distributed along the lateral members 24.

Each of the valleys 44 in each of the second supports 38 is aligned with and intersects an associated one of the valleys 34 on an associated one of the first supports 28. Thus, the first supports 28 and the second supports 38 define the baskets 18. A pair of handles 48 is provided and each of the handles 48 is coupled to and extends away from an associated one of the lateral members 24. Each of the handles 48 may be gripped.

In use, the rack 16 is positioned on the pan 12. The muffins 20 are positioned in an associated one of the baskets 18. The pan 12 and the rack 16 are placed in an oven to cook. The pan 12 and the rack 16 are removed from the oven when the muffins 20 are cooked. The rack 16 is removed from the pan 12 and the muffins 20 are allowed to cool. The muffins 20 are removed from the rack 16 when the muffins 20 have cooled.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A muffin cooking system comprising:
a pan having a plurality of indentions, said indentions being spaced apart from each other and being distributed on said pan; and
a rack being removably positioned on said pan, said rack having a plurality of wires defining baskets wherein each of said baskets is configured to contain a muffin, each of said baskets being positioned in an associated one of said indentions when said rack is removably positioned on said pan, said wires being spaced apart wherein said baskets are configured to facilitate circulation of air around the muffins to cool the muffins immediately after the muffins have been cooked.

2. The system according to claim 1, wherein said rack comprises:
an outer frame, said outer frame having a pair of lateral members extending between a pair of longitudinal members, lateral members being spaced apart from each other;
a plurality of first supports, said first supports being parallel and spaced apart from each other; and
a plurality of second supports, each of said second supports being perpendicular to said first supports.

3. The system according to claim 2, wherein:
each of said first supports is coupled to and extends between said pair of longitudinal members, said first supports being spaced apart from each other and distributed along each of said longitudinal members; and
each of said first supports has a plurality of bends thereon, said bends being spaced apart from each and other to define an alternating sequence of hills and valleys on each of said first supports.

4. The system according to claim 2, wherein:
each of said second supports is coupled to and extends between said pair of lateral members, said second supports being spaced apart from each other and distributed along each of said lateral members; and
each of said second supports having a plurality of bends thereon, said bends being spaced apart from each and other to define an alternating sequence of hills and valleys on each of said second supports.

5. The system according to claim 4, wherein:
each of said first supports having a plurality of valleys; and
each of said valleys in each of said second supports being aligned with and intersecting an associated one of said valleys on an associated one of said first supports to define said baskets.

6. The system according to claim 2, further comprising a pair of handles, each of said handles being coupled to and extending away from an associated one of said lateral members wherein each of said handles is configured to be gripped.

7. A muffin cooking system comprising:
a pan having a plurality of indentions, said indentions being spaced apart from each other and being distributed on said pan; and
a rack being removably positioned on said pan, said rack having a plurality of wires defining baskets wherein each of said baskets is configured to contain a muffin, each of said baskets being positioned in an associated one of said indentions when said rack is removably positioned on said pan, said wires being spaced apart wherein said baskets are configured to facilitate circulation of air around the muffins to cool the muffins immediately after the muffins have been cooked, said rack comprising an outer frame, said outer frame having a pair of lateral members extending between a pair of longitudinal members, lateral members being spaced apart from each other, said rack including a plurality of first supports, said first supports being parallel and spaced apart from each other, each of said first supports being coupled to and extending between said pair of longitudinal members, said first supports being spaced apart from each other and distributed along each of said longitudinal members, each of said first supports having a plurality of bends thereon, said bends being spaced apart from each and other to define an alternating sequence of hills and valleys on each of said first supports, said rack including a plurality of second supports, each of said second supports being perpendicular to said first supports, each of said second supports being coupled to and extending between said pair of lateral members, said second supports being spaced apart from each other and distributed along each of said lateral members, each of said second supports having a plurality of bends thereon, said bends being spaced apart from each and other to define an alternating sequence of hills and valleys on each of said second supports, each of said valleys in each of said second supports being aligned with and intersecting an associated one of said valleys on an associated one of said first supports to define said baskets; and
a pair of handles, each of said handles being coupled to and extending away from an associated one of said lateral members wherein each of said handles is configured to be gripped.
